(19) United States
(12) Patent Application Publication
(10) Pub. No.: US 2013/0342923 A1
(43) Pub. Date: Dec. 26, 2013

(54) LENS ATTACHING/DETACHING DEVICE AND PROJECTION DISPLAY DEVICE

(71) Applicants: Yasushi Itou, Tokyo (JP); Takahisa Yamada, Tokyo (JP); Kazuya Inoue, Tokyo (JP)

(72) Inventors: Yasushi Itou, Tokyo (JP); Takahisa Yamada, Tokyo (JP); Kazuya Inoue, Tokyo (JP)

(73) Assignee: NEC Display Solutions, LTD, Tokyo (JP)

(21) Appl. No.: 14/004,125

(22) PCT Filed: Mar. 17, 2011
(86) PCT No.: PCT/JP2011/056411

§ 371 Date: Sep. 9, 2013

(51) Int. Cl. G02B 7/14

(52) U.S. Cl. CPC G02B 7/14
USPC 359/811

(57) ABSTRACT

A lens attaching/detaching device includes a lever holding plate that has an elastic piece which presses a lock releasing lever in a direction away from a locking mechanism and holds the lock releasing lever while the lock releasing lever is guided by a lower case. The lock releasing lever includes a first sliding part and a second sliding part which are guided by the lower case. The first sliding part and the second sliding part are arranged at different positions in a Z direction and an X direction orthogonal to a Y direction. An operation part is disposed at the same position as that of the first sliding part in the Z direction. An actuation part is disposed at the same position as that of the second sliding part in the Z direction. The lower case includes a first guiding part which guides the first sliding part and the second guiding part which guides the second sliding part.

### TECHNICAL FIELD

The present invention relates to a lens attaching/detaching device for attaching or detaching a projection lens from a loading unit, and a projection display device that includes the lens attaching/detaching device.

### BACKGROUND ART

A certain projection display device includes a loading unit on which a projection lens is loaded to be detachable, and the projection display device is configured so that the projection lens can be replaced according to a distance between a projection surface to project a video and the installing position of the projection display device.

As the lens attaching/detaching structure of the loading unit of this type, a bayonet structure is used: the projection lens is inserted into the loading unit, and a flange disposed in the outer peripheral part of the projection lens is engaged with an engaging projection disposed along the circumferential direction of the inner peripheral part of the loading unit by rotating the projection lens in the circumferential direction in the loading unit. The loading unit generally includes a locking mechanism for locking the loaded projection lens.

For example, Patent Literature 1 discloses the configuration of a lens attaching/detaching device that includes the loading unit of a bayonet structure and a locking mechanism which locks a projection lens that is loaded on the loading unit.

Such a lens attaching/detaching device has a locking mechanism which locks the projection lens engaged with the loading unit, a lock releasing mechanism which releases a locked state set by the locking mechanism, and an operation member which operates the lock releasing mechanism.

The locking mechanism includes a lock lever having a lock pin which is engaged with an engaging groove formed in the outer peripheral part of the projection lens, and a spring member which presses the lock lever in a direction for engaging the lock pin of the lock lever with the engaging groove.

The lock releasing mechanism includes a lock releasing lever which moves the lock lever, a guiding member which guides the lock releasing member to freely move close to or away from the lock lever, and a spring member which presses the lock releasing lever in a direction away from the lock lever. The lock releasing lever includes an actuation part which actuates the lock lever, and an operation part which is pushed in by the operation member.

In the lock releasing mechanism, by moving the lock releasing lever via the operation member, the lock releasing lever moves the lock lever against the pressing force of the spring member. The lock lever is moved by the lock releasing lever, and thus the engaged state of the lock pin with the engaging groove of the projection lens is released.

In the lens attaching/detaching device thus configured, the lock lever of the locking mechanism and the lock releasing lever of the lock releasing mechanism must be smoothly interlocked with each other. These members may fail in operation due to even slight deformation during an operation. To reduce the influence of deformation, the locking mechanism and the lock releasing mechanism must be arranged as close as possible to each other.

The loading unit of the projection display device has a lens shifting mechanism which moves the projection lens in an optical axis direction. Between the movable part of the lens shifting mechanism and the case, in the entire region of the movable range, a structure for preventing the incursion of foreign objects such as a user's fingertip from the outside of the case is necessary. Accordingly, seen from a plane orthogonal to an optical axis that is the moving direction of the projection lens, in the movable part of the lens shifting mechanism, a flange is stacked on a gap between the movable part and the case to cover the gap. Thus, the locking mechanism is hidden on the rear side of the flange of the lens shifting mechanism.

In addition, preferably, a release button is disposed near the loading unit on the front side of the case in view of operability during lock releasing.

Because of such structural restrictions, in the lock releasing lever, the actuation part for actuating the lock lever is formed at a position facing the lock lever of the locking mechanism hidden on the rear side of the flange of the lens shifting mechanism, and the operation part operated by the release button is formed at a position facing the release button disposed on the front side of the case. Thus, the lock releasing lever is formed into a shape extending from the rear side of the flange to the front side of the case to connect the actuation part and the operation part. As a result, the lock releasing lever is formed into a shape where the position of the operation part as a power point and the position of the actuation point as an operating point are greatly shifted from each other three-dimensionally.

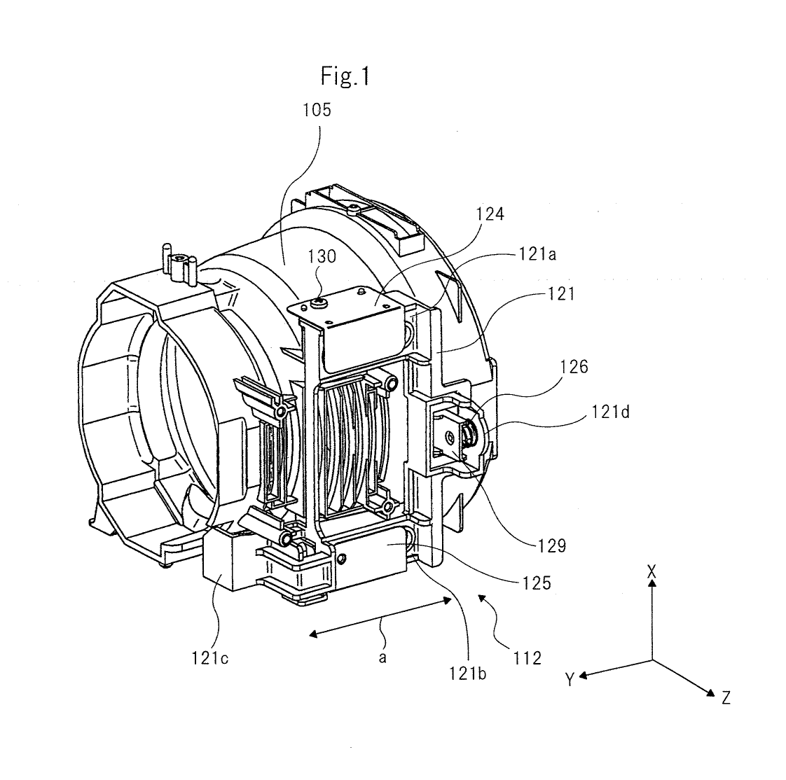

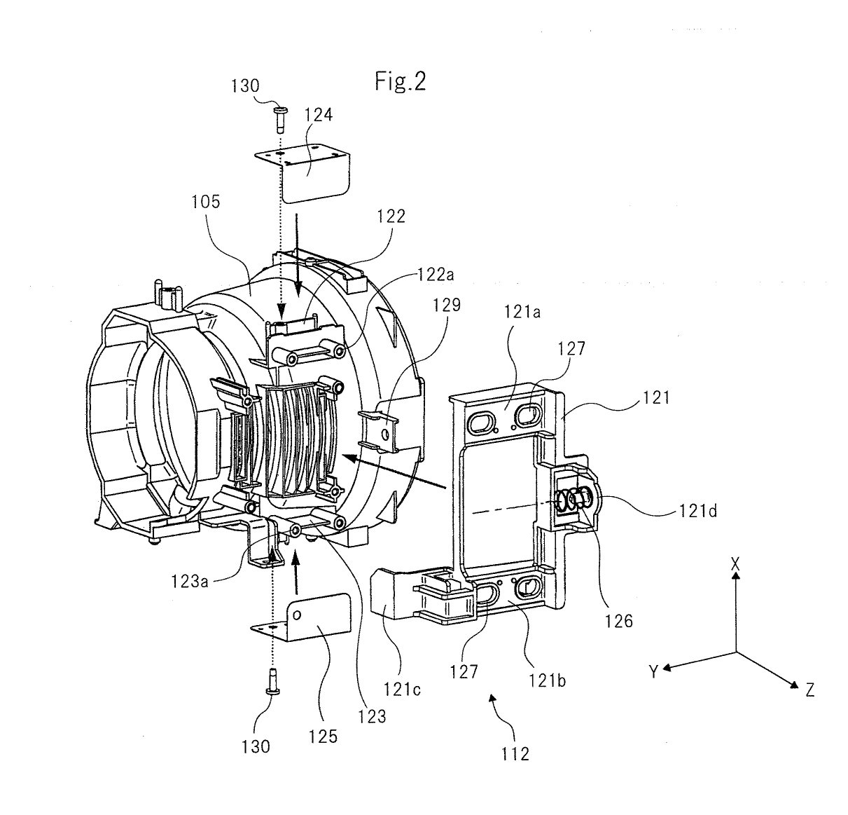

The lock releasing mechanism of a lens attaching/detaching device according to the present invention will be described. A perspective view of the lock releasing mechanism related to the present invention is shown in FIG. 1. An exploded perspective view of the lock releasing mechanism related to the present invention is shown in FIG. 2.

As shown in FIGS. 1 and 2, lock releasing mechanism 112 is disposed in the outer peripheral part of cylindrical member 105 which constitutes a loading unit. Lock releasing mechanism 112 includes lock releasing lever 12 which moves the lock lever of a locking mechanism (not shown) , a set of first and second guides 122 and 123 which guide lock releasing lever 121 to move in arrow direction away from or close to the lock lever, a set of lever holding plates 124 and 125 which hold lock releasing lever 121 guided by first and second guides 122 and 123 to be movable, and coil spring 126 which presses lock releasing lever 121 in a direction away from the lock lever.

As shown in FIG. 2, lock releasing lever 121 is formed into a square frame shape. At both ends orthogonal to a moving direction, a set of first and second sliding parts 121a and 121b which are supported by first and second guides 122 and 123 to be movable is disposed. In first and second sliding parts 121a and 121b, long guide hole 127 is formed along the moving direction of lock releasing lever 121. First and second sliding parts 121a and 121b are arranged at the same position in a Z direction shown in FIG. 2.

Lock releasing lever 121 includes actuation part 121c which actuates the lock lever of the locking mechanism, and operation part 121d which is pushed in by a release button (not shown). In operation part 121d, one end of coil spring 126 is disposed in contact with a surface that is opposite to a surface with which the release button makes contact. The other end of coil spring 126 makes contact with projection piece 129 disposed in the outer peripheral part of cylindrical member 105.

First and second guides 122 and 123 are integrally formed in the outer peripheral part of cylindrical member 105, and include guide projected parts 122a and 123a which are inserted into guide holes 127 of first and second sliding parts 121a and 121b of lock releasing lever 121.

Lever holding plates 124 and 125 are fixed to first and second guides 122 and 123 by fixing screws 130 in the held state of first and second sliding parts 121a and 121b to be movable.

### CITATION LIST

Patent Literature 1: JP2003-195419A

### SUMMARY OF INVENTION

### Problems to be Solved

Lock releasing lever 121 of lock releasing mechanism 112 according to the present invention is stably moved in a Y direction by an operation force applied to operation part 121d. Thus, second sliding part 121b is disposed at a position symmetrical to first sliding part 121a sandwiching operation part 121d.

This causes enlargement of lock releasing lever 121, and necessitates the set of lever holding plates 124 and 125 which hold first sliding part 121a and second sliding part 121b. The number of components consequently increases.

In the assembling process of lock releasing mechanism 112, coil spring 126 is attached to lock releasing lever 121, and then first and second sliding parts 121a and 121b of lock releasing lever 121 are fixed by the set of lever holding plates 124 and 125. In addition, the set of lever holding plates 124 and 125 is assembled to first and second sliding parts 121a and 121b of lock releasing lever 121 from the Z direction, and then fixed from both sides of the X direction by fixing screws 130. Thus, the assembling process of lock releasing mechanism 112 has a problem in that assembling work is complex and assembling performance is poor.

It is therefore an object of the present invention to provide a lens attaching/detaching device and a projection display device that can solve the problems of the related art. An example of the object of the present invention is to provide a lens attaching/detaching device simplified in configuration and capable of improving assembling performance.

### SOLUTION TO PROBLEM

To achieve the object, a lens attaching/detaching device according to the present invention includes a locking mechanism which locks a projection lens that is loaded on a loading unit, and a lock releasing mechanism which releases the locked state of the projection lens set by the locking mechanism.

The lock releasing mechanism includes:

a lock releasing member having an actuation part which actuates the locking mechanism to release the locked state of the projection lens set by the locking mechanism, and which has an operation part to be operated;

a guiding member which guides the lock releasing member to be movable in a direction away from or close to the locking mechanism; and

a holding member that has an elastic part which presses the lock releasing member in a direction away from the locking mechanism and that is configured to hold the lock releasing member in the guided state of the lock releasing member by the guiding member. The lock releasing member includes a first sliding part and a second sliding part which are guided by the guiding member. The first sliding part and the second sliding part are arranged at different positions in a first direction and a second direction orthogonal to the direction away from or close to the locking mechanism. The operation part is disposed at the same position as that of the first sliding part in the first direction. The actuation part is disposed at the same position as that of the second sliding part in the first direction. The guiding member includes a first guide which guides the first sliding part, and a second guide which guides the second sliding part.

A projection display device according to the present invention includes the lens attaching/detaching device of the present invention and a projection lens.

### EFFECTS OF INVENTION

According to the present invention, external force applied to the operation part of the lock releasing member is efficiently transmitted to the actuation part. According to the present invention, the lock releasing member is held by the holding member having the elastic member which presses the lock releasing member. Thus, the configuration is simplified, and the assembling performance of the lock releasing mechanism can be improved.

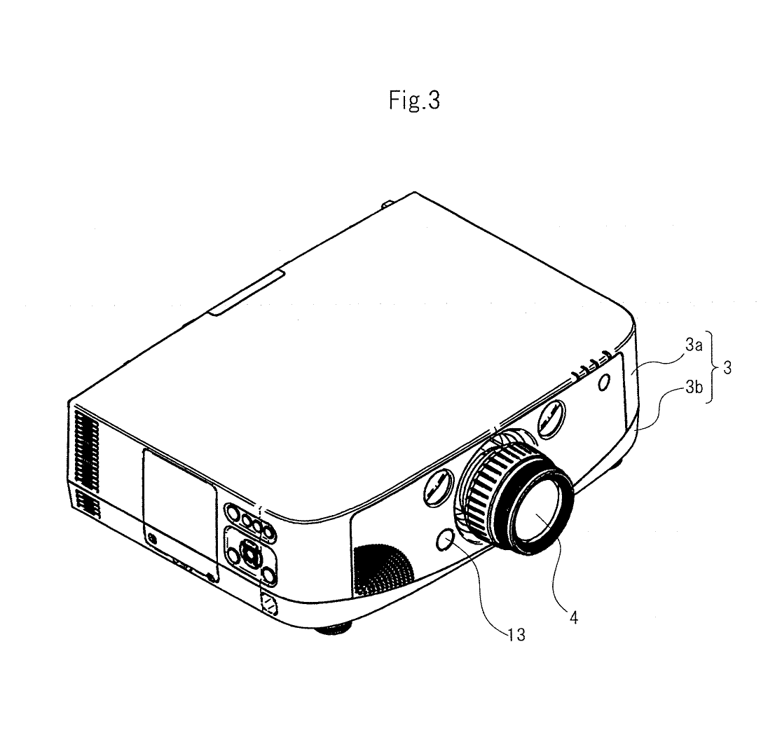

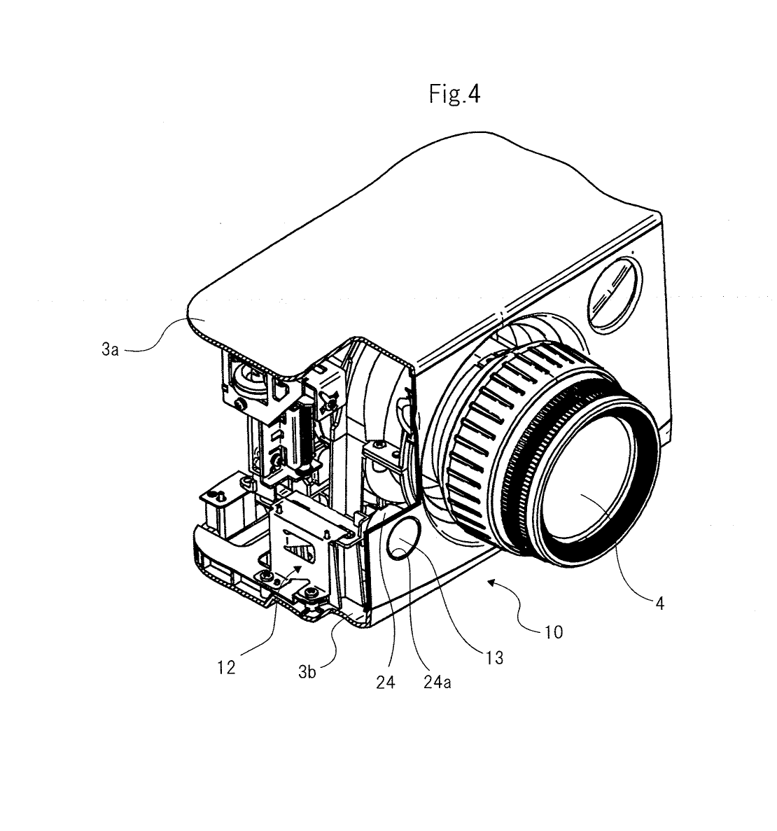

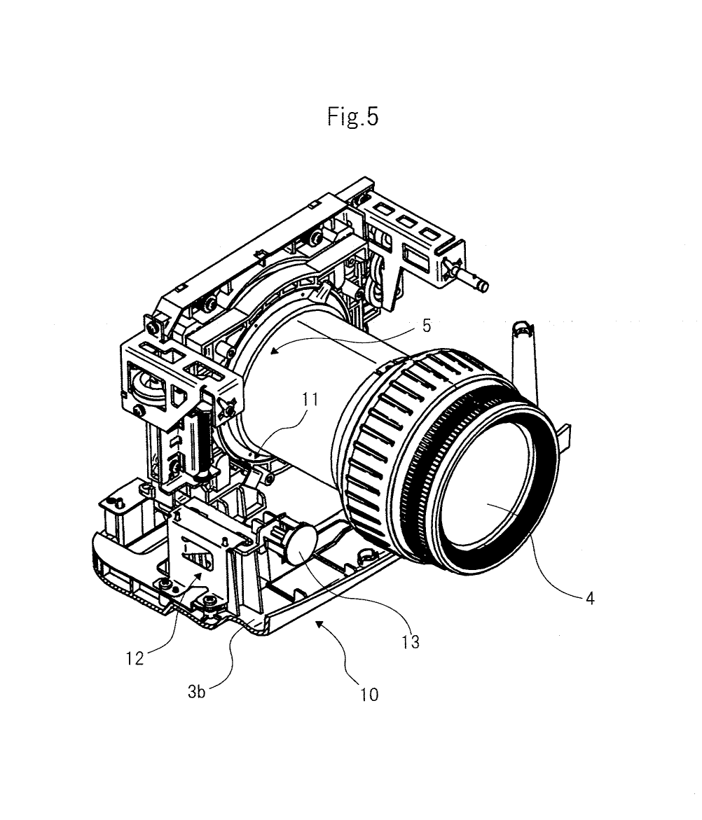

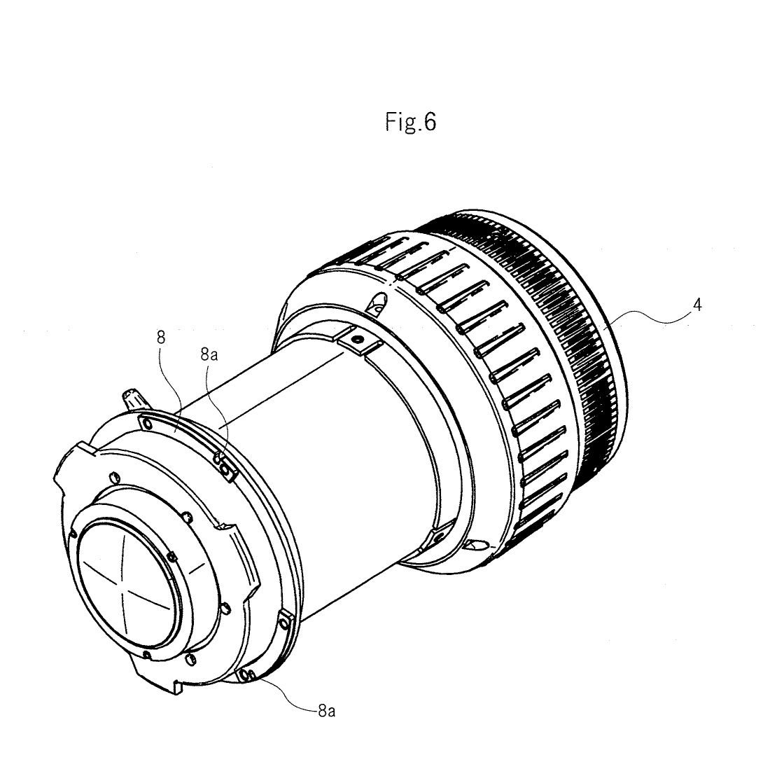

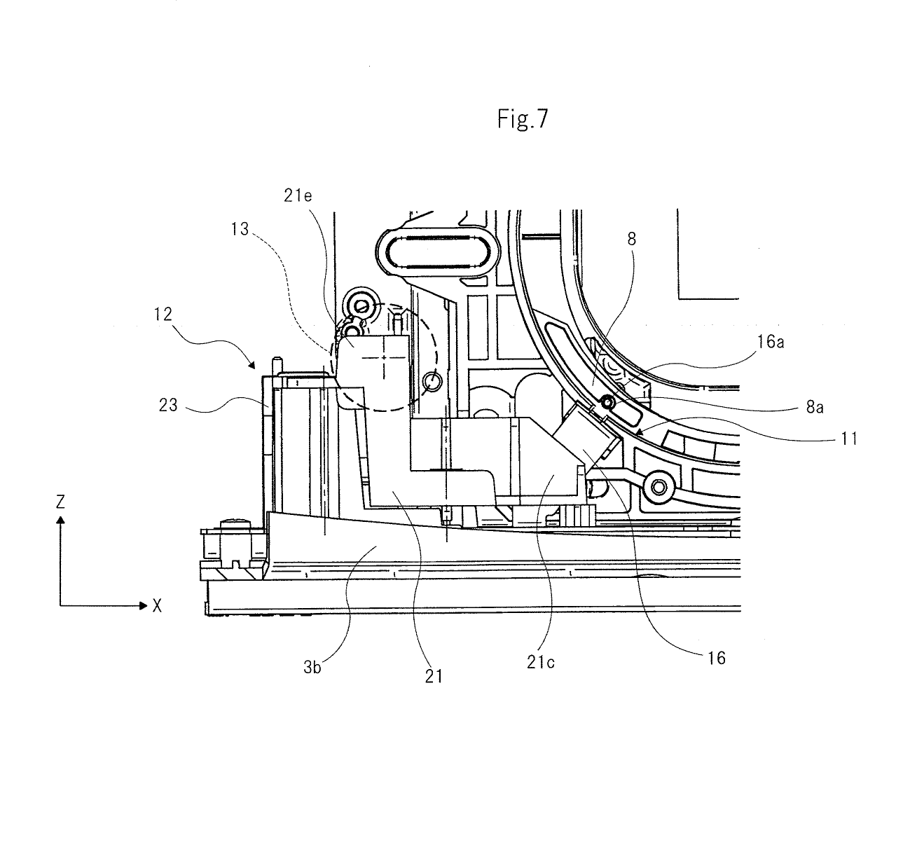

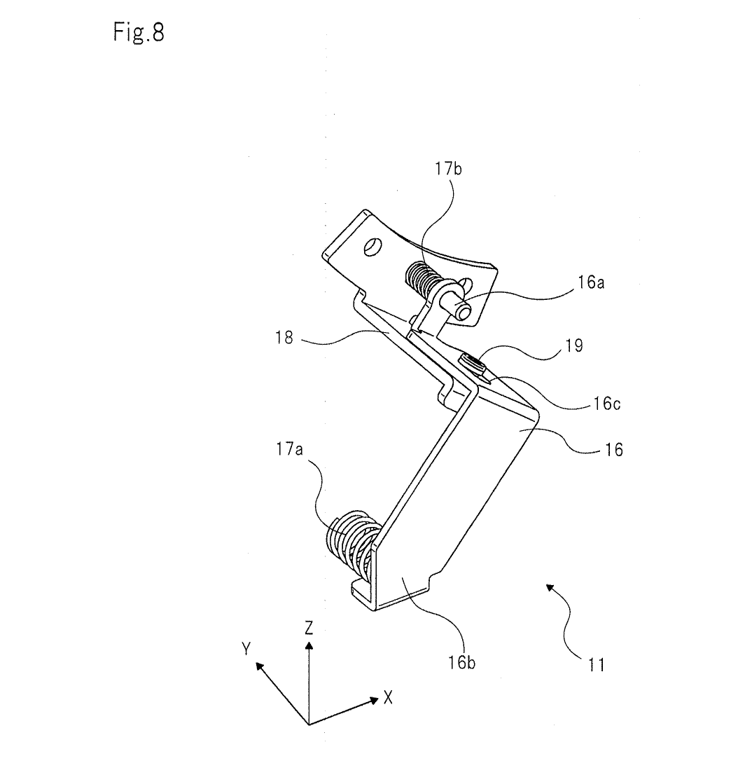

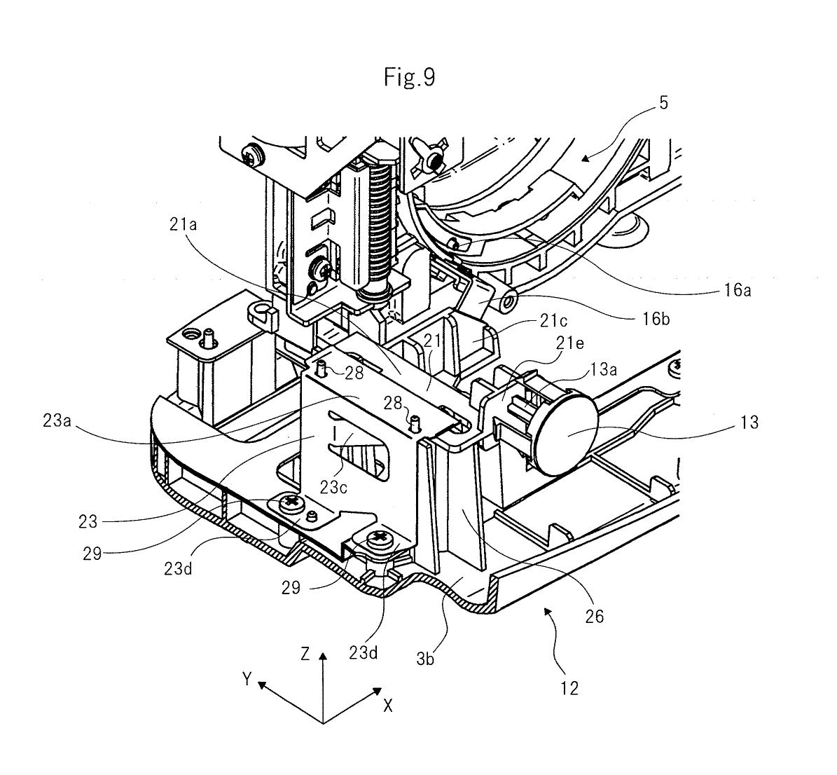

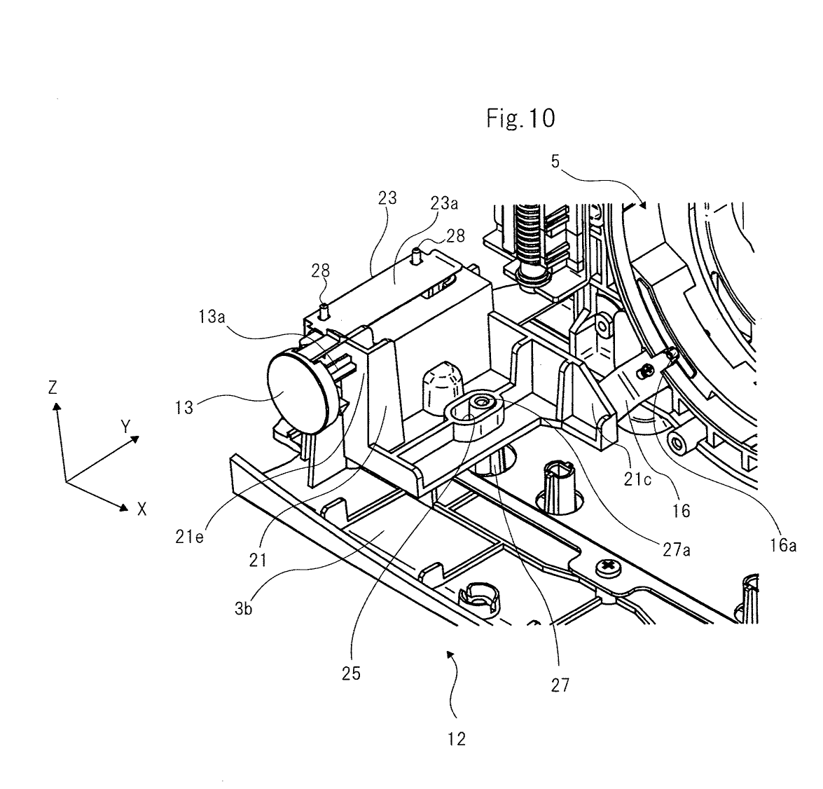

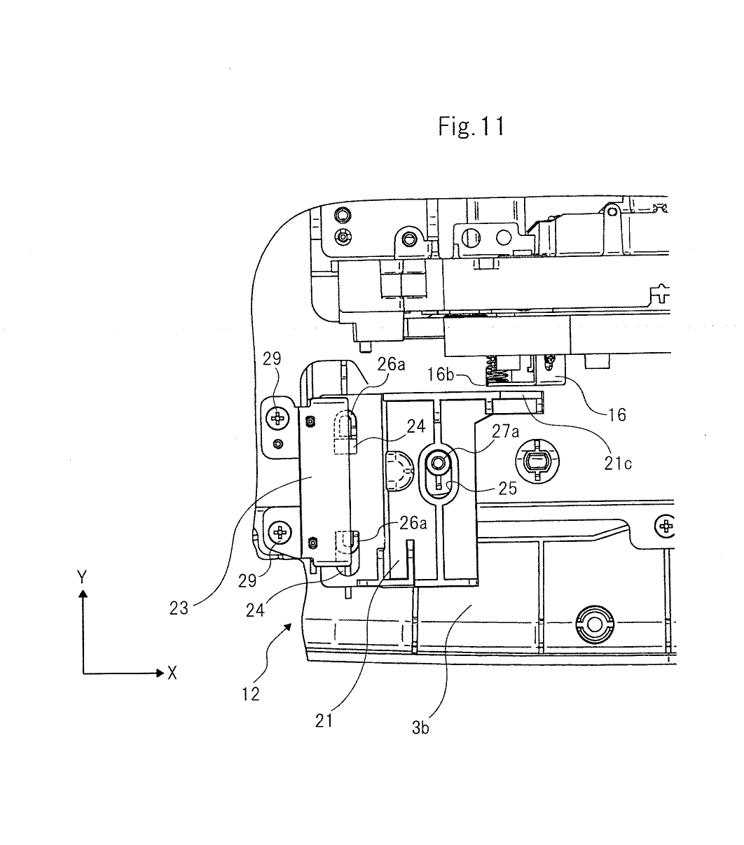

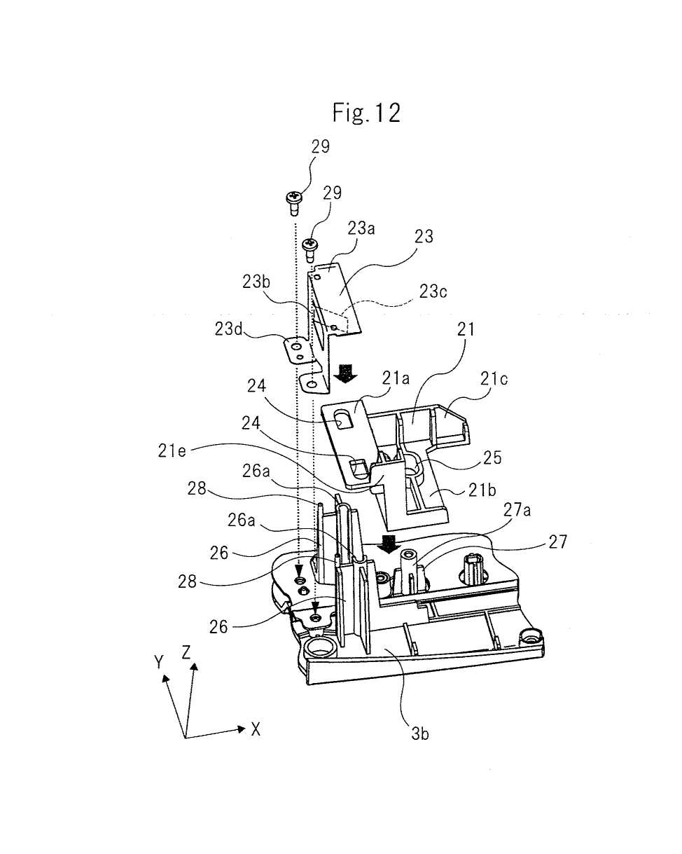

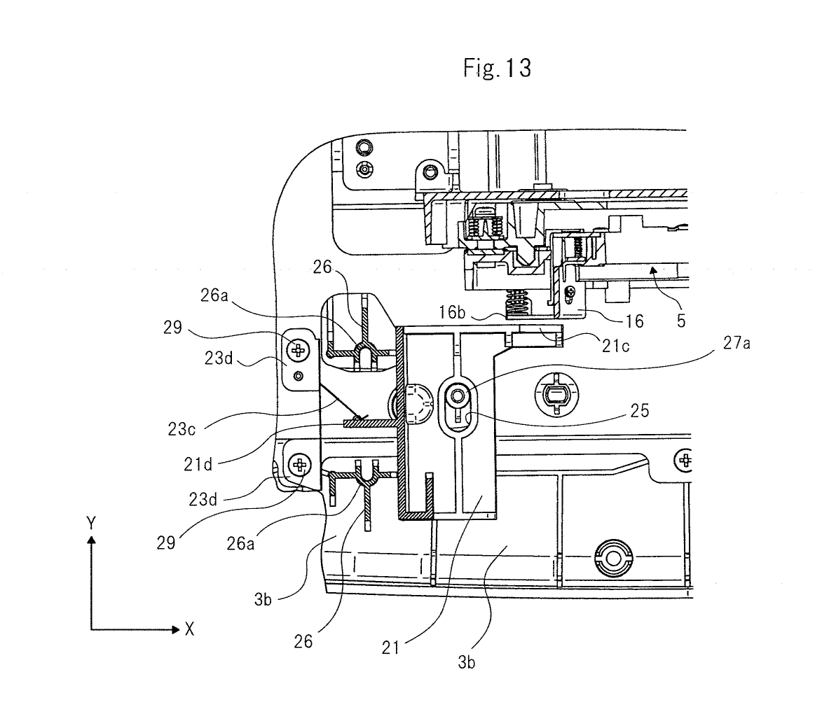

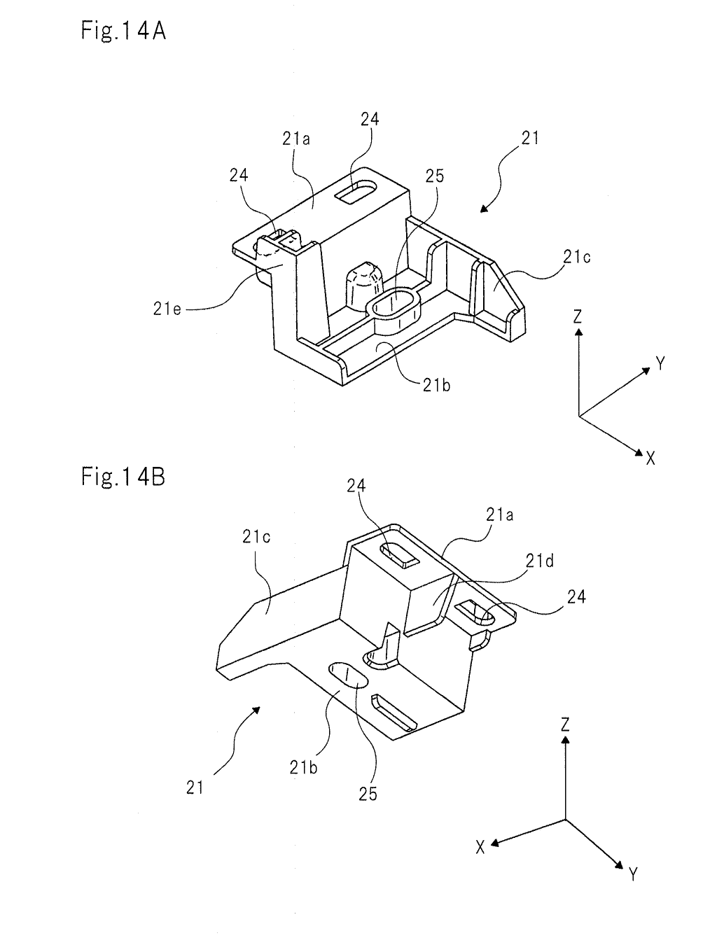

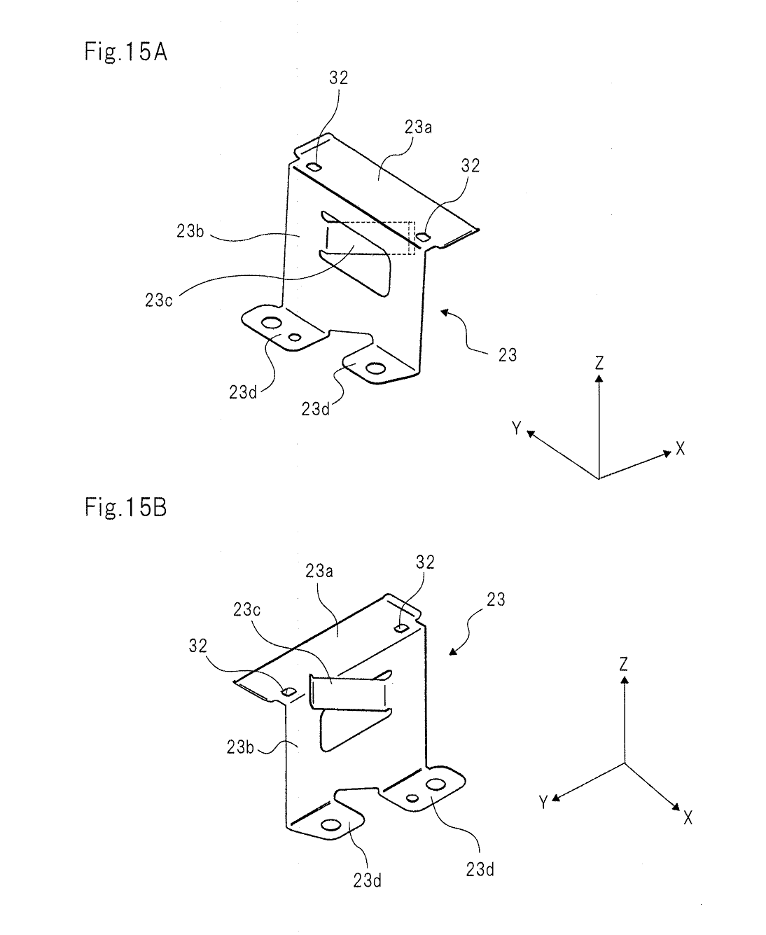

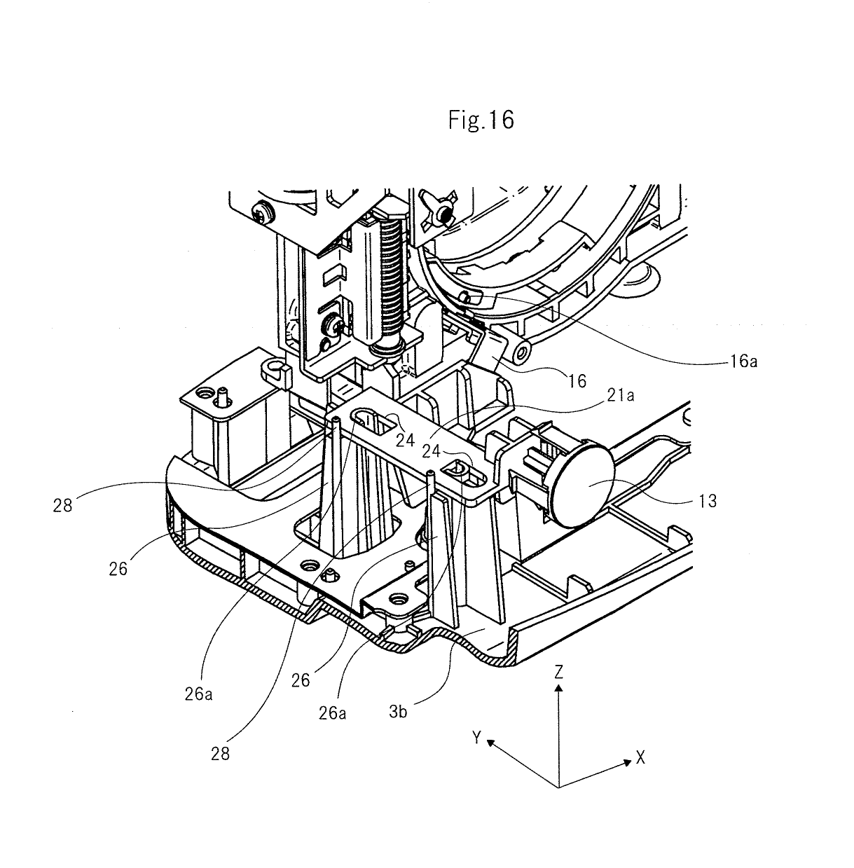

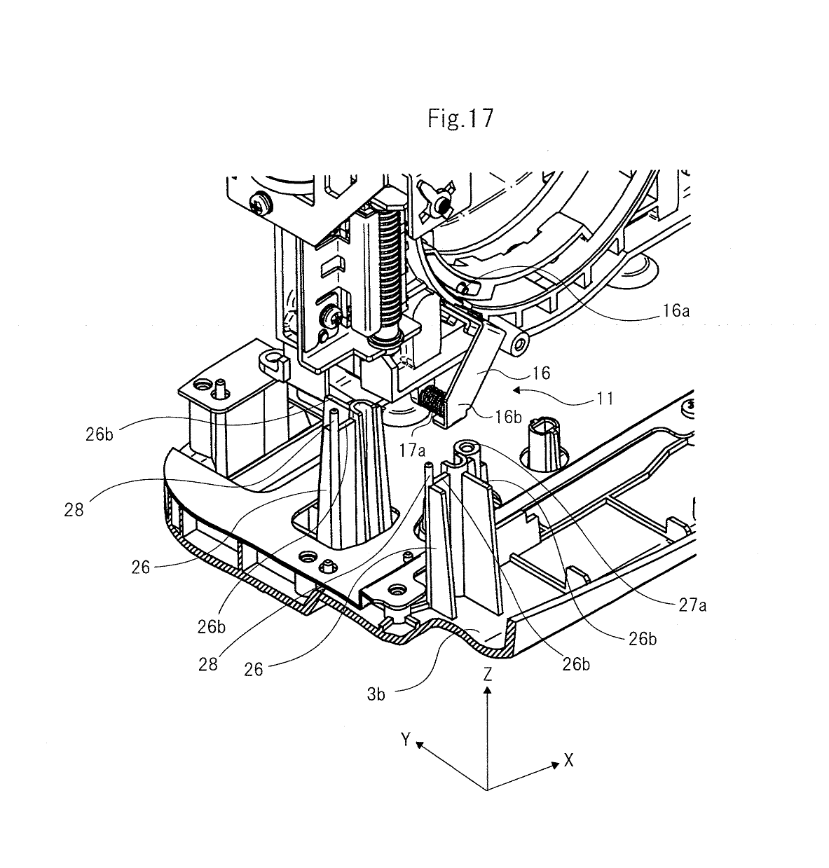

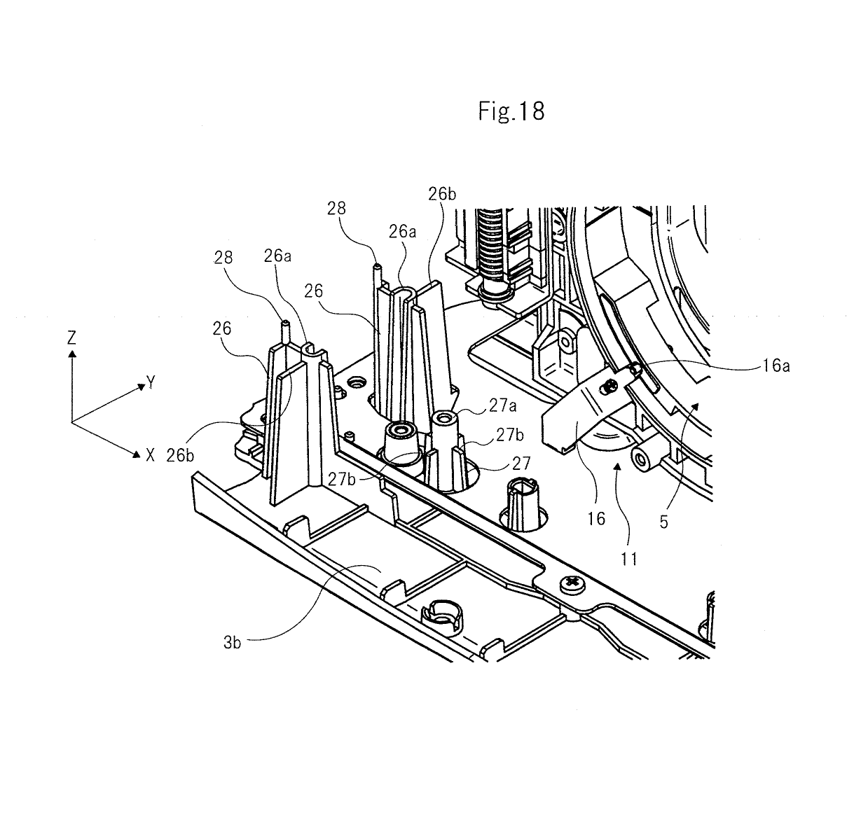

### BRIEF DESCRIPTION OF DRAWINGS

[FIG. 1] A perspective view showing a lock releasing mechanism included in a lens attaching/detaching device related to the present invention.

[FIG. 2] An exploded perspective view showing the lock releasing mechanism included in the lens attaching/detaching device related to the present invention.

[FIG. 3] A perspective view showing a projection display device according to an embodiment.

[FIG. 4] A perspective view showing a lens attaching/detaching device of the projection display device according to the embodiment.

[FIG. 5] A perspective view showing the lens attaching/detaching device of the projection display device according to the embodiment.

[FIG. 6] A perspective view showing a projection lens included in the projection display device according to the embodiment.

[FIG. 7] An explanatory front view showing a locking mechanism included in the lens attaching/detaching device according to the embodiment.

[FIG. 8] An explanatory perspective view showing the locking mechanism included in the lens attaching/detaching device according to the embodiment.

[FIG. 9] A perspective view showing a lock releasing mechanism included in the projection display device according to the embodiment.

[FIG. 10] A perspective view showing the lock releasing mechanism included in the projection display device according to the embodiment.

[FIG. 11] A plan view showing the lock releasing mechanism included in the projection display device according to the embodiment.

[FIG. 12] An exploded perspective view showing the lock releasing mechanism included in the projection display device according to the embodiment.

[FIG. 13] A cross-sectional view showing the lock releasing mechanism included in the projection display device according to the embodiment.

[FIG. 14A] A perspective view showing a lock releasing lever of the lock releasing mechanism included in the projection display device according to the embodiment.

[FIG. 14B] A perspective view showing the lock releasing lever of the lock releasing mechanism included in the projection display device according to the embodiment.

[FIG. 15A] A perspective view showing a lever holding plate of the lock releasing mechanism included in the projection display device according to the embodiment.

[FIG. 15B] A perspective view showing the lever holding plate of the lock releasing mechanism included in the projection display device according to the embodiment.

[FIG. 16] A perspective view showing the lock releasing mechanism included in the projection display device according to the embodiment.

[FIG. 17] A perspective view showing the lock releasing mechanism included in the projection display device according to the embodiment.

[FIG. 18] A perspective view showing the lock releasing mechanism included in the projection display device according to the embodiment.

### DESCRIPTION OF EMBODIMENTS

Hereinafter, the specific embodiment of the present invention will be described referring to the drawings.

A perspective view of a projection display device according to an embodiment is shown in FIG. 3. A perspective view of a lens attaching/detaching device of the projection display device according to the embodiment is shown in FIG. 4. A perspective view of the lens attaching/detaching device of the projection display device according to the embodiment is shown in FIG. 5. A perspective view of a projection lens included in the projection display device according to the embodiment is shown in FIG. 6.

As shown in FIGS. 3 and 4, the projection display device of the embodiment includes case 3 configured by combining a set of upper case 3a and lower case 3b, and lens attaching/detaching device 10 having loading unit 5 on which projection lens 4 is detachably loaded on the front side of case 3.

Loading unit 5 has a bayonet structure that includes engaging claw 7 engaged with the outer peripheral part of projection lens 4.

In the outer peripheral part of projection lens 4, as shown in FIGS. 5 and 6, flange 8 is disposed to be engaged with engaging claw 7 of loading unit 5. In flange 8, engaging groove 8a is formed to be locked by a locking mechanism included in lens attaching/detaching device 10 and described below.

As shown in FIG. 5, lens attaching/detaching device 10 has locking mechanism 11 which locks projection lens 4 loaded on loading unit 5, lock releasing mechanism 12 which releases the locked state of projection lens 4 set by locking mechanism 11, and release button 13 which actuates lock releasing mechanism 12.

An explanatory front view of locking mechanism 11 included in lens attaching/detaching device 10 according to the embodiment is shown in FIG. 7. An explanatory perspective view of locking mechanism 11 included in lens attaching/detaching device 10 according to the embodiment is shown in FIG. 8.

As shown in FIGS. 7 and 8, locking mechanism 11 includes lock lever 16 engaged with projection lens 4 loaded on loading unit 5, a pair of coil springs 17a and 17b which press lock lever 16 in a direction to engage with projection lens 4, and support member 18 which supports lock lever 16 to be movable.

As shown in FIG. 8, lock lever 16 includes lock pin 16a engaged with engaging groove 8a of flange 8 of projection lens 4, contacting piece 16b pushed in by lock releasing mechanism 12, and long guide hole 16c supported by support member 18 to be movable.

Coil spring 17a has one end which makes contact with contacting piece 16b of lock lever 16, and the other end which makes contact with a fixing part (not shown) fixed to lower case 3b. Coil spring 17b has one end which makes contact with lock pin 16a, and the other end which makes contact with support member 18. Lock lever 16 is pressed by the pair of coil springs 17a and 17b in a direction for being engaged with engaging groove 8a of projection lens 4.

Support member 18 is fixed to loading unit 5, and guide shaft 19 that is inserted into guide hole 16c of lock lever 16 is fixed to support member 18.

Perspective views of lock releasing mechanism 12 included in the projection display device according to the embodiment are shown in FIGS. 9 and 10. A plan view of lock releasing mechanism 12 included in the projection display device according to the embodiment is shown in FIG. 11. An exploded perspective view of lock releasing mechanism 12 included in the projection display device according to the embodiment is shown in FIG. 12. A cross-sectional view of lock releasing mechanism 12 included in the projection display device according to the embodiment is shown in FIG. 13.

As shown in FIGS. 9 and 10, lock releasing mechanism 12 includes lock releasing lever 21 moved by release button 13 to release the locked state of projection lens 4 set by locking mechanism 11, lower case 3b serving as a guiding member to guide lock releasing lever 21 to be movable in a Y direction away from or close to locking mechanism 11, and lever holding plate 23 serving as a holding member to hold lock releasing lever 21 in the guided state of lock releasing lever 21 by lower case 3b.

A perspective view of lock releasing lever 21 of lock releasing mechanism 12 included in the projection display device according to the embodiment is shown in FIG. 14A. A perspective view of lock releasing lever 21 of lock releasing mechanism 12 included in the projection display device according to the embodiment is shown in FIG. 14B.

Lock releasing lever 21 is made of a highly rigid resin material. As shown in FIGS. 14A and 14B, lock releasing lever 21 includes first sliding part 21a supported to be movable on lower case 3b, second sliding part 21b supported to be movable on lower case 3b, actuation part 21c for actuating lock lever 16 of locking mechanism 11, engaging part 21d with which lever holding plate 23 is engaged, and operation part 21e which is pushed in by release button 13.

As shown in FIGS. 14A, 14B, and 11, first sliding part 21a includes a set of long guide holes 24 arranged along the moving direction of lock releasing lever 21. Second sliding part 21b includes long guide hole 25 formed along the moving direction of lock releasing lever 21. Second sliding part 21b is located adjacently to first sliding part 21a in the X direction. The lengths of guide holes 24 and 25 in the Y direction are set by adding a margin of about 2.5 mm to the total of the Y-direction moving amount (about 2.5 mm) of lock lever 16 and the Y-direction clearance (about 1.5 mm) between actuation part 21c of lock releasing lever 21 and contacting piece 16b of lock lever 16.

First sliding part 21a and second sliding part 21b are arranged at different positions in the Z direction as a first direction and the X direction as a second direction orthogonal to the Y direction for bringing lock releasing lever 21 close to or away from locking mechanism 11.

Operation part 21e is disposed almost at the same position as that of first sliding part 21a in the Z direction adjacently to first sliding part 21a. Actuation part 21c is disposed almost at the same position as that of second sliding part 21b in the Z direction adjacently to second sliding part 21b. Lock releasing lever 21 is located to secure a clearance of about 1.5 mm in the Y direction between actuation part 21c and contacting piece 16b of lock lever 16.

In the Z direction, operation part 21e is disposed at the same position as that of first sliding part 21a, and actuation part 21c is disposed at the same position as that of second sliding part 21b. Accordingly, first sliding part 21a is smoothly moved by an external force applied to operation part 21e, and actuation part 21c is smoothly moved by second sliding part 21b integrally moved with first sliding part 21a. As a result, a loss of the force applied to operation part 21e is prevented, and lock releasing lever 21 can efficiently transmit the force to lock lever 16.

In addition, since operation part 21e is disposed adjacently to first sliding part 21a, and actuation part 21c is disposed adjacently to second sliding part 21b, the loss of the force applied to operation part 21e is also prevented, and the force can be more efficiently transmitted to lock lever 16. Operation part 21e and first sliding part 21a are preferably arranged as close as possible to each other on an X-Y plane, and the loss of the external force applied to operation part 21e is prevented. Similarly, actuation part 21c and second sliding part 21b are preferably arranged as close as possible to each other on the X-Y plane, and the loss of the force transmitted to actuation part 21c is prevented.

As shown in FIGS. 9 and 10, release button 13 is disposed at a position facing operation part 21e of lock releasing lever 21. Release button 13 includes contacting part 13a which makes contact with operation part 21e of lock releasing lever 21.

As shown in FIG. 4, button support part 24 that supports release button 13 to be movable in a direction close to or away from operation part 21e of lock releasing lever 21 is disposed on the front side of upper case 3a. Button support part 24, which is formed into a cylindrical shape, includes opening 24a which exposes the pushed-in surface of release button 13 oppositely to the outside. Button support part 24 also includes a coil spring (not shown) which presses release button 13 in a direction away from operation part 21e of lock releasing lever 21.

As shown in FIGS. 12 and 13, lower case 3b includes a set of first guides 26 which support first sliding part 21a of lock releasing lever 21 to be movable, and second guide 27 which supports second sliding part 21b of lock releasing lever 21 to be movable.

Perspective views of lock releasing mechanism 12 included in the projection display device according to the embodiment are shown in FIGS. 16 to 18. As shown in FIGS. 16 and 17, first guide 26 includes a set of guide projected parts 26a inserted into the set of guide holes 24 of first sliding part 21a of lock releasing lever 21. The leading end of guide projected part 26a of guide hole 24 is projected upward from first sliding part 21a. As shown in FIGS. 17 and 18, first guide 26 includes a plurality of end surfaces 26b for supporting the lower surface side of first sliding part 21a of lock releasing lever 21.

Second guide 27 includes guide projected part 27a inserted into guide hole 25 of second sliding part 21b of lock releasing lever 21. Second guide 27 includes a plurality of end surfaces 27b for supporting the lower surface side of second sliding part 21b of lock releasing lever 21.

Lower case 3b includes positioning pin 28 for positioning holding piece 23a of lever holding plate 23 at a position adjacent to first guide 26.

A perspective view of lever holding plate 23 of lock releasing mechanism 12 included in the projection display device according to the embodiment is shown in FIG. 15A. A perspective view of lever holding plate 23 of lock releasing mechanism 12 included in the projection display device according to the embodiment is shown in FIG. 15B.

As shown in FIGS. 15A and 15B, lever holding plate 23, which is formed by folding a metal plate, includes holding piece 23a for pressing and holding first sliding part 21a of lock releasing lever 21, side plate 23b having elastic piece 23c as an elastic part for pressing lock releasing lever 21 in a direction where lock releasing lever 21 is separated from lock lever 16, and fixing piece 23d fixed on lower case 3b by fixing screw 29 as shown in FIG. 12.

Holding piece 23a includes positioning hole 32 engaged with positioning pin 28 of the set of first guides 26. Holding piece 23a is prevented from positional shifting by the engagement between positioning pin 28 and positioning hole 32. Holding piece 23a makes contact with guide projected part 26a that is inserted into guide hole 24 to movably hold first sliding part 21a that is supported by first guide 26.

Elastic piece 23c is formed as a leaf spring by cutting and raising a part of side plate 23b. Elastic piece 23c is engaged with engaging part 21d of lock releasing lever 21 to press lock releasing lever 21 in a direction away from lock lever 16. Elastic piece 23c is formed to be deformed within an elastic limit in the moving range of lock releasing lever 21 moved in the Y direction.

The axial direction of fixing screw 29 for fixing fixing piece 23d to lower case 3b is parallel to the projection direction of guide projected parts 26a and 27a. Accordingly, as in the case of lock releasing lever 21 and lever holding plate 23 assembled to lower case 3b from the Z direction, fixing screw 29 can be fastened from the Z direction, and workability during assembling is improved.

For lens attaching/detaching device 10 included in the projection display device, which is configured as described above, the operation of releasing the locked state of projection lens 4 set by locking mechanism 11 will be described.

In the loaded state of projection lens 4 on loading unit 5, lock pin 16a of lock lever 16 of locking mechanism 11 is engaged with engaging groove 8a of flange 8 of projection lens 4 by the pressing forces of coil springs 17a and 17b.

When release button 13 is pushed in, operation part 21e of lock releasing lever 21 is moved in the Y direction against the elastic force of elastic piece 23c of lever holding plate 23. When operation part 21e is moved in the Y direction, in lock releasing lever 21, first and second sliding parts 21a and 21b are moved with respect to first and second guides 25a and 26a, and actuation part 21c of lock releasing lever 21 makes contact with contacting piece 16b of lock lever 16. Thus, lock lever 16 is moved in the Y direction against the pressing forces of coil springs 17a and 17b, thereby releasing the engaged state between lock pin 16a and engaging groove 8a of projection lens 4. As a result, projection lends 4 can be detached from loading unit 5.

A method for manufacturing lock releasing mechanism 12 included in lens attaching/detaching device 10 will be described briefly.

The method for manufacturing lock releasing mechanism 12 includes the first step of inserting guide projected parts 26a and 27a of first and second guides 25 and 26 of lower case 3b into guide holes 24 and 25 of first and second sliding parts 21a and 21b of lock releasing lever 21, and locating lock releasing lever 21 on lower case 3b, the second step of locating lever holding plate 23 over first sliding part 21a of lock releasing lever 21 disposed on lower case 3b and lower case 3b, and the third step of fixing lever holding plate 23 for holding first sliding part 21a of lock releasing lever 21to lower case 3b. In the third step, by fastening fixing screw 29 from the Z direction that is the projection direction of guide projected parts 26a and 27a, fixing piece 23d of lever holding plate 23 is fixed to lower case 3b.

According to the manufacturing method, since lock releasing lever 21 is held only by one lever holding plate 23, assembling work can be simplified. According to the manufacturing method, lock releasing lever 21, lever holding plate 23, and fixing screw 29 can all be assembled to the lower case 3b only from the Z direction, and workability during assembling can be improved.

As described above, according to the embodiment, even in the case of lock releasing lever 21 where operation part 21e and actuation part 21c are formed into a three-dimensionally separated shape, in the Z direction, operation part 21e as the power point to which the external force is applied and first sliding part 21a are arranged at the same position, and actuation part 21c as the actuation point for actuating locking mechanism 11 and second sliding part 21b are arranged at the same position, and thus the force applied to operation part 21e can be efficiently transmitted to actuation part 21c. As a result, according to the embodiment, the operation reliability of lock releasing mechanism 12 can be improved.

According to the embodiment, lock releasing lever 21 is held by lever holding plate 23 having elastic piece 23c for pressing lock releasing lever 21. Thus, a configuration is simplified, and the assembling performance of lock releasing mechanism 12 can be improved.

### Reference Numerals

1 Projection display device
3b Lower case
4 Projection lens
5 Loading unit
10 Lens attaching/detaching device
11 Locking mechanism
12 Lock releasing mechanism
13 Release button
21 Lock releasing lever
21a First sliding part
21b Second sliding part
23 Lever holding plate
23c Elastic piece
26 First guide
27 Second guide

What is claimed is:

1. A lens attaching/detaching device comprising:
a locking mechanism which locks a projection lens that is loaded on a loading unit; and
a lock releasing mechanism which releases the locked state of the projection lens set by the locking mechanism,
wherein the lock releasing mechanism includes:
a lock releasing member having an actuation part which actuates the locking mechanism to release the locked state of the projection lens set by the locking mechanism, and having an operation part to be operated;
a guiding member which guides the lock releasing member to be movable in a direction away from or close to the locking mechanism; and
a holding member that has an elastic part which presses the lock releasing member in a direction away from the locking mechanism and that is configured to hold the lock releasing member in the guided state of the lock releasing member by the guiding member;
the lock releasing member includes a first sliding part and a second sliding part which are guided by the guiding member, the first sliding part and the second sliding part being arranged at different positions in a first direction and a second direction orthogonal to the direction away from or close to the locking mechanism;
the operation part is disposed at the same position as that of the first sliding part in the first direction;
the actuation part is disposed at the same position as that of the second sliding part in the first direction; and
the guiding member includes a first guide which guides the first sliding part, and a second guide which guides the second sliding part.

2. The lens attaching/detaching device according to claim 1, wherein:
the operation part is located adjacently to the first sliding part; and
the actuation part is located adjacently to the second sliding part.

3. The lens attaching/detaching device according to claim 2, wherein the holding member holds the first sliding part to be movable.

4. The lens attaching/detaching device according to claim 3, wherein:
the first and second sliding parts have guide holes;
the first and second guides have guide projected parts inserted into the guide holes; and
a projection direction of the guide projected parts is parallel to an axial direction of a screw for fixing the holding member to the guiding member.

5. The lens attaching/detaching device according to claim 1, wherein:
the holding member has the elastic part formed into a leaf spring shape; and
the lock releasing member has an engaging part engaged with the elastic part.

6. A projection display device comprising:
the lens attaching/detaching device according to claim 1; and the projection lens.
